(19) United States
(12) Patent Application Publication
(10) Pub. No.: US 2014/0007779 A1
(43) Pub. Date: Jan. 9, 2014

(54) Bread Maker and Ice Cream Accessory

(71) Applicants: Richard Hoare, Lane Cove (AU); Garth Ryan, Helensburgh (AU)

(72) Inventors: Richard Hoare, Lane Cove (AU); Garth Ryan, Helensburgh (AU)

(73) Assignee: Breville Pty Limited, Botany, NSW (AU)

(21) Appl. No.: 14/006,312

(22) PCT Filed: Mar. 22, 2012
(86) PCT No.: PCT/AU2012/000296

§ 371 Date: Sep. 19, 2013

(30) Foreign Application Priority Data
Mar. 22, 2011 (AU) 2011901047

(51) Int. Cl. A23G 9/22

(52) U.S. Cl. CPC A23G 9/22
USPC 99/342; 99/352

(57) ABSTRACT

A combination bread making and ice cream making machine has a specially configured interface, a freezer bowl and an ice cream making scraper blade.

### FIELD OF THE INVENTION

The invention relates to bread makers and more particularly to an interface and an ice cream making accessory for same.

### BACKGROUND OF THE INVENTION

Automated bread making machines are well known. Domestic examples include the Breville® BBM800, BBM600, BBM300 and BBM100.Such bread makers are adapted to mix raw ingredients, knead dough and add selected ingredients such as fruit and nuts, automatically, at the correct time. Because of the need to select between manual and various automatic programs and utilise features such as delayed timers, loaf size and other user selectable parameters, a user interface is required. The user interface comprises a display and controls for selecting the various features and options.

A bread maker also utilises an electric motor to drive the mixing or kneading blade in a removable vessel or loaf pan (“the pan”). A drive coupling is permanently mounted into the interior floor of the bread making machine and cooperates with a female coupling on the underside of the removable pan. Accordingly, the male coupling is now understood to be capable of driving an ice cream making accessory, in a bread making machine.

### OBJECTS AND SUMMARY OF THE INVENTION

It is an object of the invention to provide an improved user interface for a bread making machine.

It is also an object of the invention to provide an ice cream making accessory for a bread making machine.

It is a further object of the invention to provide an interface for a combination bread and ice cream making machine.

### BRIEF DESCRIPTION OF THE DRAWING FIGURES

In order that the invention be better understood, reference is now made to the following drawing figures in which:

FIG. 1 is a perspective view of a bread making machine;

FIG. 2 is a perspective view of an ice cream making bowl and scraper blade for a bread making machine;

FIG. 3 is an underside perspective view of the device depicted in FIG. 2;

FIG. 4 is an exploded perspective of the device depicted in FIG. 2;

FIG. 5 is a top plan view, cross sectioned to reveal the interior of an ice cream bowl with alternate heat transfer fins;

FIG. 6 is a top plan view, cross sectioned to reveal the interior of an ice cream bowl with alternate heat transfer fins;

FIG. 7 is a top plan view, of a round ice cream bowl, sectioned to reveal the heat transfer fins;

FIG. 8 is a cross sectional view of a bread making machine accommodating an ice cream bowl; and

FIG. 9 is a plan view of a user interface of a combination bread and ice cream making machine; and

FIG. 10 is another view of the interface depicted in FIG. 9.

### BEST MODE AND OTHER EMBODIMENTS

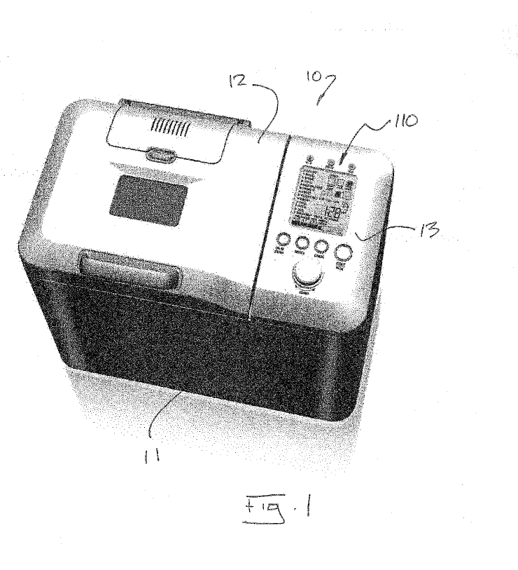

As shown in FIG. 1, an automated domestic bread maker 10 comprises a housing 11 having a hinged, top opening lid 12 and a user interface 13 located, for example, on an upper surface of the housing 11. The hinged lid 12 opens to reveal a compartment that is adapted to receive a removable loaf pan. The pan is used to receive raw ingredients, combine them and hold the ingredients during the cooking process that results in a loaf. The container is then removed and the loaf is demoulded whereby the container can then be washed and reused.

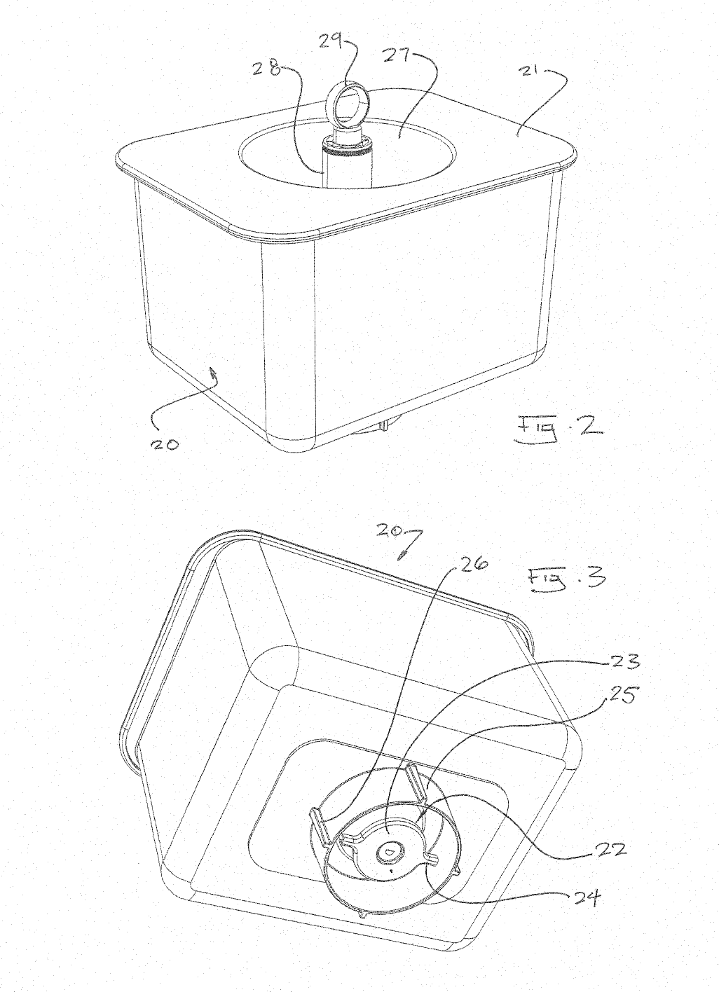

FIGS. 2 and 3 illustrate an ice cream making accessory 20 that can be used with a bread maker 10. The accessory comprises a generally rectangular freezer bowl 21 having the outward shape, configuration and size of (or no larger than) a removable pan for a particular bread making machine. As shown in FIG. 3, the freezer bowl 20 further comprises a coupling component 22 that is adapted to be engaged by the rotating coupling located within the interior compartment of a bread making machine. In this example, the coupling component 22 comprises a circular disc 23 having radial extensions 24 that are located 180 degrees from one another. Other coupling configurations may be used. The coupling component 22 is surrounded by a stabilising collar 25 that is integral with the bottom of the freezer bowl 20. The collar 25 has one or more ribs 26 that engage with cooperating features within the compartment and that stabilise the freezer bowl 20 when the coupling component 22 is being rotated by the bread maker's electric motor. The collar may conceal a gearbox. In the example of FIGS. 2 and 3 the ice cream bowl 20 is illustrated as a generally rectangular sealed vessel having a central, round reservoir 27 that receives the ingredients for ice cream or frozen dessert making. The reservoir 27 is round in cross section so as to receive an ice cream stirring and scraping blade 28 that is removable using an uppermost ring-like handle 29.

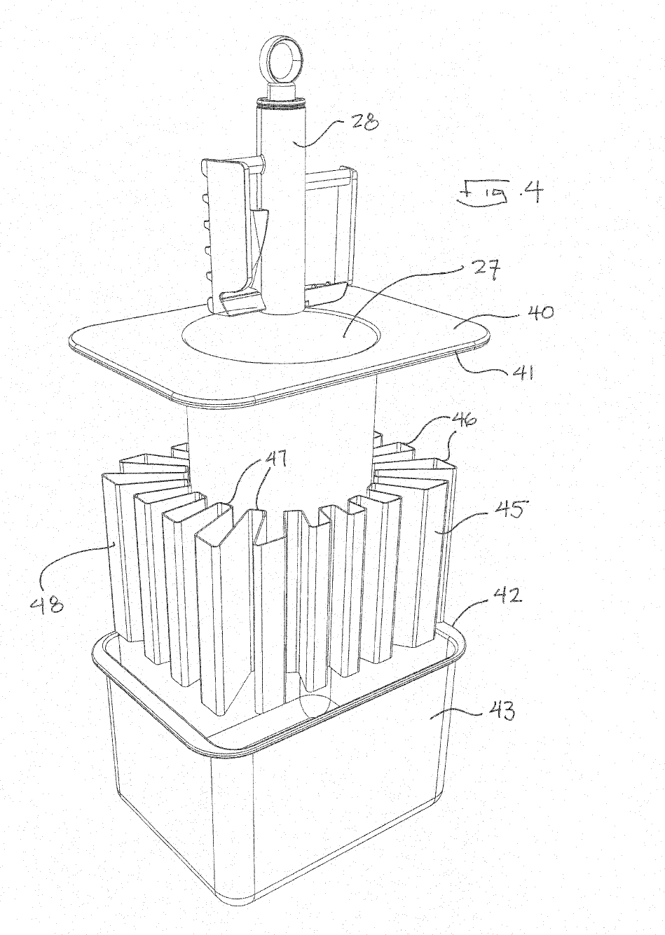

FIG. 4 illustrates the mixing and scraping blade 28 and how it fits into the reservoir 27. In this example, the reservoir body is affixed to a cover 40. The edge 41 of the cover is permanently sealed against the rim 42 of the rectangular body 43 of the ice cream bowl. In preferred embodiments, the body is a polymer such as a polypropylene. The space between the reservoir 27 and the body 43 is filled with both a freezer gel (or like substance) and an array of heat transfer fins 45. The fins may be a continuous corrugated array or made from several pieces that are either assembled separately or joined into a continuous array. In this example, the array 45 comprises a configuration of corrugations 46 formed from a thermally conductive material such as a metal. Each of the corrugations has a flattened inward directed surface 47 that preferably makes surface contact with the outside surface of the reservoir 27. The fins assist in transferring heat away from the reservoir and into the freezer gel. Each of the corrugations also has a radially outward flat surface 48 intended to make contact with the inner wall of the body 43. In preferred embodiments, the lid 40 and reservoir 27 are a conductive metal such as aluminium.

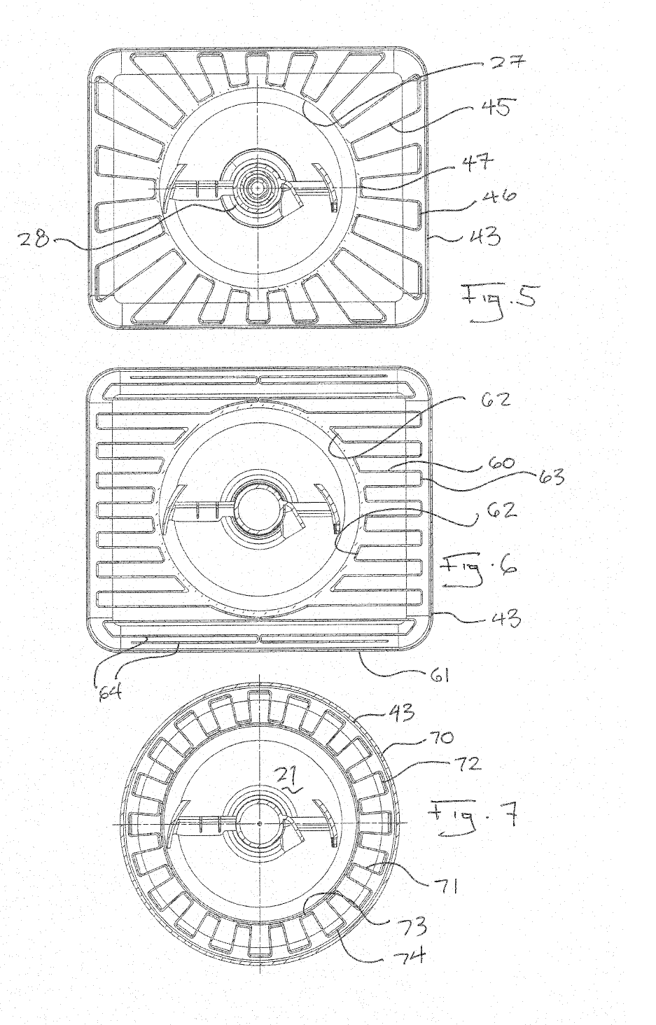

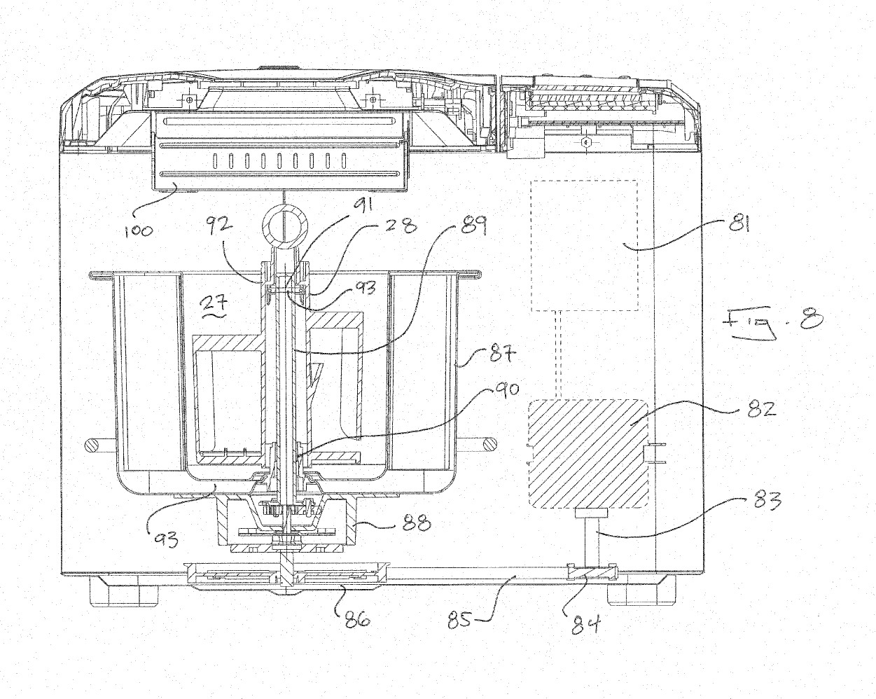

A top plan view of the interior of the body 43 is shown in FIG. 5. An alternate array of heat conductive ribs 60 is shown in FIG. 6. In this array, the ribs form a labyrinth pattern, each rib being generally parallel with the long edges 61 of the body 43. The array is structured so that ribs have reservoir facing surfaces that lie close to or in surface contact with the outer surface of the reservoir 27. Thermal communication with the body 43 is maintained by providing flat surfaces 63 where a rib comes closest to the inner wall of the receptacle 43. Additional heat transfer capacity is provided by optionally providing a double wall 64 on those ribs that are closest to and parallel with a side of the receptacle 43. FIG. 7 illustrates a further example where the freezer bowl 70 is round rather than rectangular. In this example, the array of ribs 71 comprises a periodic radial arrangement of like or similar ribs 72, each having terminal ends or tips 73, 74 in contact with or closely adjacent either the outer surface of the reservoir 27 or the inner surface of the body 43.

As shown in FIG. 8, mixing and scraping blade 28 is preferably driven by a top drive arrangement. In this arrangement, a microprocessor device 81 regulates and controls an electric motor 82 with a vertical and downward extending output shaft 83. The output shaft 83 terminates in a gear 84. The gear 84 drives a belt 85 that is connected to a gear or sheave 86 located directly below the freezer bowl 87 when it is installed. A planetary gear box 88 is located between the belt drive assembly and the main drive shaft 89. In preferred embodiments, the planetary gear box is contained within the collar and thus forms a part of the freezer bowl. The drive shaft 89 extends through the interior floor surface of the bread making machine and is protected by a tube 90 sealed with respect to the interior of the bread making machine. The drive shaft 89 extends, for practical purposes, to the upper extent of the mixing and scraping blade 28 when it is installed. Power or torque is transmitted to the blade 28 by a spline or coupling arrangement that extends between the top 91 of the drive shaft and the top or upper extent 92 of the blade. Thus, the rotating drive shaft does not need to be directly sealed with respect to the bottom of the reservoir 27. Thus, leakage from the reservoir 27 can only occur by fluids that reach the level of the seal 93 at the top of the drive shaft, this being generally above the nominal operating capacity of the reservoir 27. FIG. 8 also illustrates that the freezer bowl 87 can have a double walled bottom 93, thus allowing freezer gel to be located below the interior floor of the reservoir 27. FIG. 8 also illustrates an automated hopper 100. The one or more such hoppers 100 may be provided under the lid of the device. The hopper may be pre-filled with ingredients such as nuts or fruit etc. that would otherwise be dispensed into a bread making pan. These ingredients may be discharged into the ice cream mixture residing in the pan 27 at the appropriate time. In general, softer ingredients will be discharged closer to the end time of the ice cream making process.

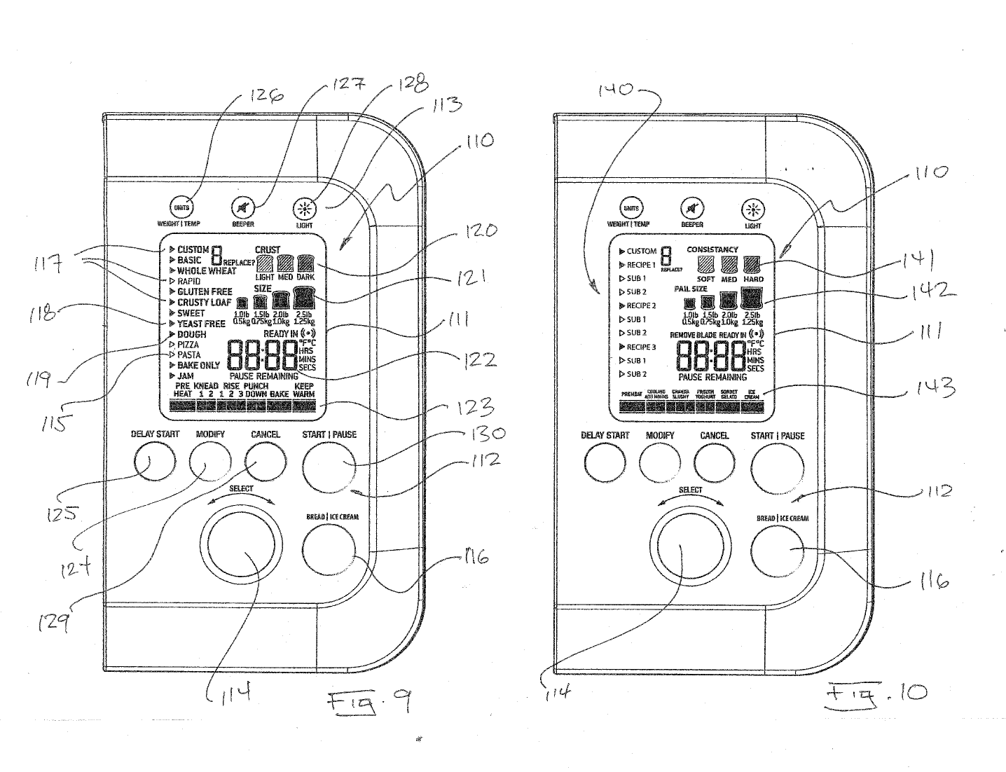

As shown in FIG. 9, an interface for a combination bread making and ice cream making machine comprises a graphic display area 111 user inputs 115 located below the graphical interface 111 and other user inputs 113 located above the graphical interface 111. The inputs may be mechanical or electro mechanical buttons, switches etc and in this example at least one rotary selector knob 114 is provided below the graphical display 111 and preferably centred about the longitudinal mid line of the display 111. A significant feature of the graphical display 111 is a list 115 that is toggled by a user input 116 between a bread baking mode display and an ice cream making mode display (shown in FIG. 10). In the bread baking mode, as shown in FIG. 9, individual bread recipes 117 are depicted in a vertical list, in text form. Each individual listing 118 is coupled with an indicator 119 that shows whether or not a particular item in the list has been selected by the user using the rotating selection knob 114. Accordingly, the inputs required from the user begins with a selection from one or more items in the list of entries 117. Upon selection, a set of default instructions is carried out by the device's micro processor. However, these default settings can be modified by the user. The upper right hand of the graphical display 111 shows, for example, three symbols that each represent a slice of bread. In this array of symbols 120, one of the slices represents light crust, one represents medium crust and one represents dark crust. Below the crust selection indicator symbols 120, there is an array of bread size indicator symbols 121. The symbols are graduated, in increasing sizes, and labelled with typical loaf sizes, e.g. 0.5 kg, 0.75 kg, 1 kg and 1.25 kg. One portion of the display comprises a numeric countdown timer array 122 that provides feedback regarding the time remaining for a particular user selection. At the lower extent of the display 111 there is a graphic progress bar 123. Segments of the process bar are activated or illuminated, in sequence, to indicate phases of the bread making process such as preheat, knead, rise, punch down, bake and keep warm. In preferred embodiments, selections are made by sequentially pressing the “modified” button 124, then rotating the selection knob 114 and then pressing the selection 114 to confirm a selection. One user input 125 allows the bread making process to be delayed by increments selected then confirmed with the selector knob 114. Another user input 126 toggles between imperial and metric units in respect of weight and temperature. The row of user inputs above the display 111 comprises the imperial or metric toggle 126, a beeper on/off toggle 127 and a light toggle 128. The row of buttons or user inputs below the display 111 comprises the delay start selector 125, the recipe modify input 124, a cancel button 129 and a start and pause selector 130. When the machine is in a bread making mode, use of the input or toggle for bread/ice cream 116 causes the functionality of the machine to change and consequently these changes are reflected in the graphical display 111. These changes are illustrated in FIG. 10. Importantly, the list of recipes changes from break recipes to frozen dessert recipes 140. In the area where crust darkness selection symbols were previously displayed, the display now shows ice cream consistency with different symbols 141. The symbols 141 each indicate, for example, soft, medium or hard ice cream. Where loaf size selection symbols 121 were previously displayed, frozen dessert batch or pail size is displayed 142. Text information 143 above the progress bar indicates the stages of frozen dessert preparation, including dessert type, in order of how long each recipe takes. In this example, the progress bar 143 has individual segments that are activated or illuminate indicate recipes pre-heat, cooling and mixing, granita or slushie, frozen yoghurt, sorbet or gelato and ice cream. Activating the toggle 116 returns the functionality and display characteristics to those discussed with reference to FIG. 9.

While the present invention has been disclosed with reference to particular details of construction, these should be understood as having been provided by way of example and not as limitations to the scope or spirit of the invention.

What is claimed is:

1. An ice cream making device for a bread making machine, comprising:
a generally rectangular freezer bowl having the outward shape and size of a removable pan for a particular bread making machine.

2. The device of claim 1, wherein:
the freezer bowl further comprises a coupling component that is adapted to be engaged by the rotating coupling located within an interior compartment of said bread making machine.

3. The device of claim 1, wherein:
the coupling component comprises a circular disc having radial extensions.

4. The device of claim 3, wherein:
the coupling component is surrounded by a stabilising collar having one or more ribs that engage with cooperating features of the machine and that stabilise the freezer bowl when the coupling component is being rotated by a motor.

5. The device of claim 4, wherein:
the collar conceals a gearbox.

6. The device of claim 1, wherein:
the freezer bowl is generally rectangular, having a central, round reservoir that receives the ingredients for frozen dessert making.

7. The device of claim 6, wherein:
a space between the reservoir and a body of the freezer bowl is filled with both a freezer substance and an array of heat transfer fins.

8. The device of claim 7, wherein:
the fins may are corrugations forming an array of thermally conductive material.

9. The device of claim 8, wherein:
each corrugation has a flattened inward directed surface that makes surface contact with a surface of the reservoir.

10. The device of claim 8, wherein:
each corrugation also has a radially outward flat surface that makes contact with an inner wall of the body.

11. The device of claim 7, wherein:
the array comprises ribs that form a labyrinth pattern, each rib being generally parallel with an edge of the body.

12. The device of claim 11, wherein:
the array is structured so that ribs have reservoir facing surfaces that lie close to or in surface contact with an outer surface of the reservoir.

13. A device, being in combination, a bread making machine, ice cream making bowl and scraper blade, wherein:
the scraping blade is driven by a top drive arrangement.

14. The device of claim 13, comprising:
a microprocessor that regulates an electric motor having a vertical drive shaft that drives a belt that is connected to a sheave located directly below the freezer bowl.

15. The device of claim 14, wherein:
a planetary gear box is located between the belt and the drive shaft.

16. The device of claim 15, wherein:
the planetary gear box is contained within a collar of the bowl.

17. The device of claim 16, wherein:
the drive shaft extends through an interior floor surface of the bread making machine and is protected by a tube sealed with respect to the interior of the bread making machine.

18. The device of claim 17, wherein:
the drive shaft extends to an upper extent of the blade when it is installed and power is transmitted to the blade by a coupling arrangement that extends between a top of the drive shaft and an upper extent of the blade.

19. The device of claim 13, further comprising:
an automated hopper under a lid of the device.

20. A combination bread making and ice cream making device comprising:
a graphic display area having user inputs wherein a list is toggled by a user input between a bread baking mode display and an ice cream making mode display.

21. The device of claim 20 wherein:
in the bread baking mode, individual bread recipes are depicted in a vertical list, in text form, each individual item in the list is coupled with an indicator that shows whether or not a particular item in the list has been selected by the user using a rotating selection knob.
